(19) United States
(12) Patent Application Publication
(10) Pub. No.: US 2023/0360001 A1
(43) Pub. Date: Nov. 9, 2023

(54) SYSTEMS AND METHODS FOR CONTROLLING ACCESS TO VERIFIED CREDENTIALS DURING RECRUITMENT

(71) Applicant: WORKWOLF INC., TORONTO (CA)

(72) Inventors: ERIK ILMARS SIMINS, MISSISSAUGA (CA); DANIEL PATRICK SHEA, RICHMOND HILL (CA); RONALD ROBERT LEITH, MARKHAM (CA)

(21) Appl. No.: 17/912,812

(22) PCT Filed: Mar. 17, 2021
(86) PCT No.: PCT/CA2021/050356

§ 371 Date: Sep. 19, 2022

Related U.S. Application Data
(60) Provisional application No. 62/992,590, filed on Mar. 20, 2020.

(51) Int. Cl. G06Q 10/1053; G06F 21/62

(52) U.S. Cl. CPC G06Q 10/1053; G06F 21/6245

(57) ABSTRACT

Systems and methods are provided for controlling access, of an employer, to verified credentials associated with a candidate during a recruitment process, such that the employer is protected from accessing the verified credential prior to delivery of the offer of employment. In some example embodiments, a confirmation is received indicating that the candidate has provided authorization that permits access of an employer to a verified credential associated with the candidate. Access of the employer to the verified credential is prevented until after a digital employment offer is verified and communicated to the candidate. After having communicated the digital offer of employment to the candidate, access of the employer to the verified credential is permitted. In some example embodiments, the authorization of access of the employer to the verified credential is stored as a variable in a smart contract of a distributed ledger.

### CROSS-REFERENCE TO RELATED APPLICATION

This application claims priority to U.S. Provisional Patent Application No. 62/992,590, titled “SYSTEMS AND METHODS FOR CONTROLLING ACCESS TO VERIFIED CREDENTIALS DURING RECRUITMENT” and filed on Mar. 20, 2020, the entire contents of which is incorporated herein by reference.

### BACKGROUND

The present disclosure relates to computer systems and associated methods for the automated management and verification of credentials associated with an individual. More particularly, the present disclosure relates to computer systems and associated methods for automated credential verification during candidate recruitment and other human resource processes.

Conventional hiring practices typically involve a long, costly process of candidate sourcing, screening, and, as a final step, performing a background check. This final step is fraught with challenges, including high costs and long delays. The background check process typically involves many manual steps that together result in a long delay—typically days or weeks—in obtaining all of the information necessary to be able to proceed with offering a position to a candidate.

A significant risk and cost associate with the latency of the background check process is the high risk of a key candidate accepting an alternative offer during the time interval during which the results from a background check are pending. The loss of such a candidate can have a high associated cost in view of the significant time and effort made during the selection process, not to mention the cost of the background check itself. Delays in obtaining results from background checks also present hidden costs to the both the potential employer and the recruiter, such as the cost associated with delayed onboarding, (such as an operating room sitting idle waiting on a new surgeon or the construction of a skyscraper and it's construction workers on hold waiting on a new crane operator), of the appropriate candidate and delayed hiring commissions, respectively.

### SUMMARY

Systems and methods are provided for controlling access, of an employer, to verified credentials associated with a candidate during a recruitment process, such that the employer is protected from accessing the verified credential prior to delivery of the offer of employment. In some example embodiments, a confirmation is received indicating that the candidate has provided authorization that permits access of an employer to a verified credential associated with the candidate. Access of the employer to the verified credential is prevented until after a digital employment offer is verified and communicated to the candidate. After having communicated the digital offer of employment to the candidate, access of the employer to the verified credential is permitted. In some example embodiments, the authorization of access of the employer to the verified credential is stored as a variable in a smart contract of a distributed ledger.

Accordingly, in a first aspect, there is provided a system for controlling access to a verified credential associated with a candidate during recruitment, the system comprising:
a central computing subsystem comprising at least one processor and associated memory, the memory comprising instructions executable by said at least one processor to perform operations comprising:
   receiving authorization input confirming that a candidate has provided authorization permitting access of an employer to the verified credential;
   while preventing access of the employer to the verified credential:
      receiving a digital employment offer purported to comprise of an offer of employment to the candidate from the employer;
      processing the digital employment offer to confirm inclusion, in the digital employment offer, of the offer of employment to the candidate from the employer, thereby verifying the digital employment offer;
      communicating the offer of employment to the candidate; and
   after communicating the offer of employment to the candidate, providing access of the employer to the verified credential, thereby protecting the employer from accessing the verified credential prior to delivery of the offer of employment.

In some implementations of the system, the digital employment offer includes an offer letter, and the central computing subsystem is configured to process the offer letter to identify, within the offer letter, the offer of employment to the candidate by the employer. The central computing subsystem may be configured to process the offer letter according to a natural language processing algorithm or using a machine learning algorithm.

In some implementations of the system, the digital employment offer is received, by the central computing subsystem, as a set of inputs associated with fields of an offer letter template, where the central computing subsystem is configured to process at least one of the inputs to confirm a presence of the offer of employment.

In some implementations of the system, the central computing subsystem is configured to receive, from the candidate, confirmation of receipt of the offer of employment prior to providing access of the employer to the verified credential.

In some implementations of the system, the central computing subsystem is configured to communicate, to the employer, a presence of the verified credential, without providing access to the verified credential, prior to communicating the offer of employment to the candidate.

In some implementations of the system, the central computing subsystem is configured such that access of the employer to the verified credential is terminated after a prescribed time duration.

In some implementations of the system, the verified credential is a first verified credential, where the authorization permits access of the employer to a second verified credential, and where the central computing subsystem is further configured to provide access of the employer to the second verified credential prior to communicating the offer of employment to the candidate.

In some implementations of the system, the central computing subsystem is further configured to store the verified credential, and/or permissions associated therewith, in an encrypted state.

In some implementations of the system, the central computing subsystem is connectable to a computing device associated with the candidate for receiving the authorization input.

In some implementations of the system, the central computing subsystem forms a node of a distributed ledger, where the central computing subsystem is configured to obtain the authorization input by executing a smart contract associated with the distributed ledger, the smart contract storing a state variable associated with a presence or absence of authorization of access of the employer to the verified credential. The central computing subsystem may be configured to store the verified credential, in an encrypted state, on the distributed ledger. The central computing subsystem may be configured such that, after communicating the offer of employment to the candidate, access of the employer to the verified credential is provided by including, in the distributed ledger, an encrypted form of the verified credential, the encrypted form of the verified credential being generated according to a public key associated with the employer.

In some implementations of the system, the central computing subsystem is configured such that, after communicating the offer of employment to the candidate, access of the employer to the verified credential is provided by communicating an encrypted form of the verified credential to the employer, the encrypted form of the verified credential being generated according to a public key associated with the employer.

In some implementations of the system, the central computing subsystem is configured such that, after communicating the offer of employment to the candidate, access of the employer to the verified credential is provided by communicating, to the employer, an encryption key suitable for decrypting an encrypted form of the verified credential.

In another aspect, there is provided a method of controlling access to a verified credential associated with a candidate during recruitment, the method comprising, employing a central computing subsystem to perform operations comprising:
receiving authorization input confirming that a candidate has provided authorization permitting access of an employer to the verified credential;
while preventing access of the employer to the verified credential:
   receiving a digital employment offer purported to comprise of an offer of employment to the candidate from the employer;
   processing the digital employment offer to confirm inclusion, in the digital employment offer, of the offer of employment to the candidate from the employer, thereby verifying the digital employment offer;
   communicating the offer of employment to the candidate; and
after communicating the offer of employment to the candidate, providing access of the employer to the verified credential, thereby protecting the employer from accessing the verified credential prior to delivery of the offer of employment.

The digital employment offer may include an offer letter, where the offer letter is processed by the central computing subsystem to identify, within the offer letter, the offer of employment to the candidate by the employer. The offer letter may be processed by the central computing subsystem according to a natural language processing algorithm. The offer letter may be processed by the central computing subsystem using a machine learning algorithm.

In some implementations of the method, the digital employment offer may be received, by the central computing subsystem, as a set of inputs associated with fields of an offer letter template, and wherein at least one of the inputs are processed by the central computing subsystem to confirm a presence of the offer of employment.

In some implementations, the method may further include receiving, from the candidate, confirmation of receipt of the offer of employment prior to providing access of the employer to the verified credential.

In some implementations of the method, the method may further include, prior to receiving a digital employment offer, employing the central computing subsystem to communicate, to the employer, a presence of the verified credential, without providing access to the verified credential.

In some implementations of the method, the central computing subsystem is configured such that access of the employer to the verified credential is terminated after a prescribed time duration.

In some implementations of the method, the authorization from the candidate permitting the employer to view the verified credential is conditional upon receipt of the offer of employment.

In some implementations of the method, legislation within a jurisdiction in which one or both of the candidate and the employer reside prohibits disclosure of the verified credential prior to the provision of the offer of employment to the candidate, such that compliance of the employer with the legislation is automatically achieved by only permitting the employer to access the verified credential after the offer of employment is communicated to the candidate.

In some implementations of the method, the verified credential is a first verified credential, and wherein the authorization permits access of the employer to a second verified credential, the method further comprising:

providing access of the employer to the second verified credential prior to communicating the offer of employment to the candidate.

In some implementations of the method, the second verified credential is associated with an educational degree obtained by the candidate and the first verified credential is associated with a criminal background check performed on the candidate.

In some implementations of the method, the verified credential is stored by the central computing subsystem in an encrypted state.

In some implementations of the method, the authorization input is received from a computing device associated with the candidate.

In some implementations of the method, the authorization input is obtained by executing, via the central computing subsystem, a smart contract associated with a distributed ledger, the smart contract storing a state variable associated with a presence or absence of authorization of access of the employer to the verified credential.

In some implementations of the method, the verified credential is stored, in an encrypted state, on the distributed ledger.

In some implementations of the method, the smart contract is executable by the candidate, through a user interface employing an application programming interface, to modify the state variable. After communicating the offer of employment to the candidate, access of the employer to the verified credential may be provided by including, in the distributed ledger, an encrypted form of the verified credential, the encrypted form of the verified credential being generated according to a public key associated with the employer.

In some implementations of the method, after communicating the offer of employment to the candidate, access of the employer to the verified credential is provided by communicating an encrypted form of the verified credential to the employer, the encrypted form of the verified credential being generated according to a public key associated with the employer.

In some implementations of the method, after communicating the offer of employment to the candidate, access of the employer to the verified credential is provided by communicating, to the employer, an encryption key suitable for decrypting an encrypted form of the verified credential.

In some implementations of the method, sourcing of the verified credential was initiated by the candidate.

In some implementations of the method, sourcing of the verified credential was initiated by the employer.

In another aspect, there is provided a system for controlling access to a verified credential associated with a candidate during recruitment, the system comprising:
a central computing subsystem comprising at least one processor and associated memory, the memory comprising instructions executable by said at least one processor to perform operations comprising:
   receiving first input confirming that a candidate has provided authorization permitting access of an employer to the verified credential;
   while preventing access of the employer to the verified credential, awaiting second input confirming that an offer of employment has been made to the candidate by the employer; and
   after receiving the second input confirming that an offer of employment has been made to the candidate by the employer, providing access of the employer to the verified credential, thereby protecting the employer from accessing the verified credential prior to delivery of the offer of employment.

In another aspect, there is provided a method of controlling access to a verified credential associated with a candidate during recruitment, the method comprising, employing a central computing subsystem to perform operations comprising:
receiving first input confirming that a candidate has provided authorization permitting access of an employer to the verified credential;
while preventing access of the employer to the verified credential, awaiting second input confirming that an offer of employment has been made to the candidate by the employer; and
after receiving the second input confirming that an offer of employment has been made to the candidate by the employer, providing access of the employer to the verified credential, thereby protecting the employer from accessing the verified credential prior to delivery of the offer of employment.

In another aspect, there is provided a system for controlling access to a verified credential associated with a first entity during a contract generation process, the system comprising:
a central computing subsystem comprising at least one processor and associated memory, the memory comprising instructions executable by said at least one processor to perform operations comprising:
   receiving authorization input confirming that the first entity has provided authorization permitting access of a second entity to the verified credential;
   while preventing access of the second entity to the verified credential:
      receiving a digital document purported to comprise of a contract between the second entity and the first entity;
      processing the digital document to confirm inclusion, in the digital document, of the contract between the second entity and the first entity, thereby verifying the digital document;
      communicating the contract to the first entity; and
   after communicating the contract to the first entity, providing access of the second entity to the verified credential, thereby protecting the second entity from accessing the verified credential prior to delivery of the contract.

In another aspect, there is provided a method of controlling access to a verified credential associated with a first entity during a contract generation process, the method comprising, employing a central computing subsystem to perform operations comprising:
receiving authorization input confirming that the first entity has provided authorization permitting access of a second entity to the verified credential;
while preventing access of the second entity to the verified credential:
   receiving a digital document purported to comprise of a contract between the second entity and the first entity;
   processing the digital document to confirm inclusion, in the digital document, of the contract between the second entity and the first entity, thereby verifying the digital document;
   communicating the contract to the first entity; and
after communicating the contract to the first entity, providing access of the second entity to the verified credential, thereby protecting the second entity from accessing the verified credential prior to delivery of the contract.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 shows an example system for automating access to and management of a verified credential associated with a candidate during recruitment.

FIG. 2A is a flow chart illustrating an example automated method for automating access to and management of a verified credential associated with a candidate during recruitment.

FIG. 2B is a flow chart illustrating another example automated method for automating access to and management of a verified credential associated with a candidate during recruitment.

FIG. 3 shows an example system for automating access to and management of a verified credential associated with a candidate during recruitment, in which permission is recorded in a distributed ledger.

FIG. 4 shows an example of a central computing device suitable controlling access and management of a verified credential associated with a candidate during recruitment.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any subranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

As noted above, conventional approaches to implementing background screening during the hiring process can lead to numerous problems, including high costs and long delays. The present inventors sought to address these problems by developing an automated, computer-based solution, in which background screening results could be obtained and made available earlier during the hiring process in order to enable an employer to present an offer of employment to a specific candidate with reduced latency.

Unfortunately, the early availability of background screening results can present challenges for the employer in terms of compliance with legislation associated the hiring process. Indeed, in many jurisdictions, prospective employers are legally barred from accessing some background screening results prior to presenting an offer of employment to a selected candidate. For example, many regions in the United States have adopted “ban the box” legislation, which prohibits agencies from inquiring into a job applicant's criminal records until later in the hiring process.

This constraint presents a technical challenge in designing automated, computer-based solutions in which background screening results associated with a selected candidate are obtained prior to the delivery of an offer of employment to the selected candidate. The present inventors therefore determined that any suitable technical solution to the aforementioned problem should include an automated constraint that prevents, or at least impairs, the ability of the employer to intentionally or inadvertently access background screening results prior to the delivery of the offer of employment, such that compliance with appropriate recruitment legislation is enforced or encouraged.

Accordingly, various example embodiments of the present disclosure provide automated, computer-based systems and methods in which access to a verified credential associated with a candidate is controlled such that the employer is prevented or discouraged prior to delivery of the offer of employment.

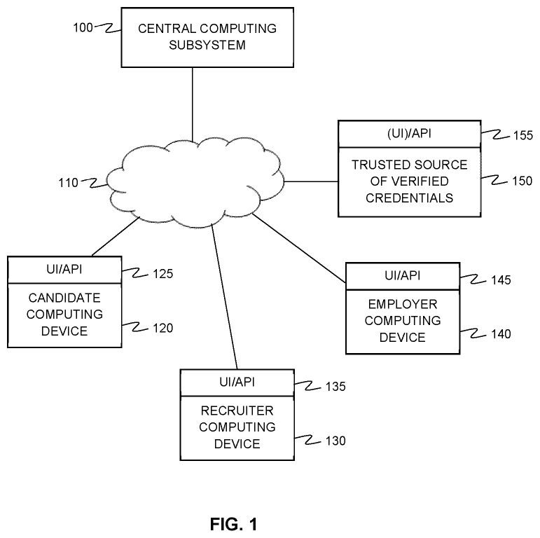

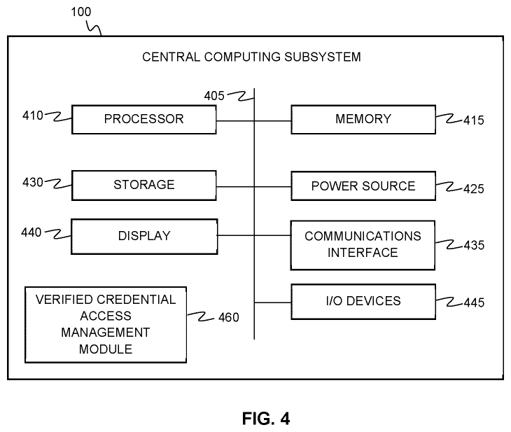

Referring now to FIG. 1, an example system is presented for controlling access to a verified credential associated with a candidate during recruitment. The example system employs a central computing subsystem 100, which manages access to a verified credential associated with a candidate, such as a result from a criminal background check (other verified credentials may include, but are not limited to education, motor vehicle licensing, and professional certification). The central computing system 100 is connectable, through a network 110, to one or more remote computing devices, including, for example, a candidate computing device 120, a recruiter computing device 130, an employer computing device 140, and a computing device associated with a trusted source of the verified credential 150 (such as a background screening service). Any one or more of the remote computing devices may be operatively connectable to the central computing subsystem 100 though a respective user interface (e.g. browser or application; “app”) and an application programming interface (API), such as example UI/APIs 125, 135, 145 and 155. An example embodiment of the central computing subsystem is presented in further detail below, with reference to FIG. 4.

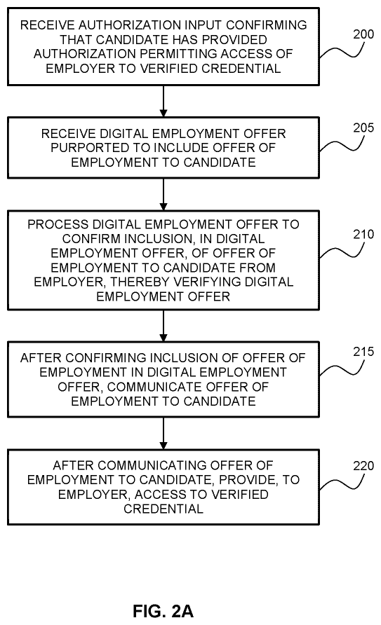

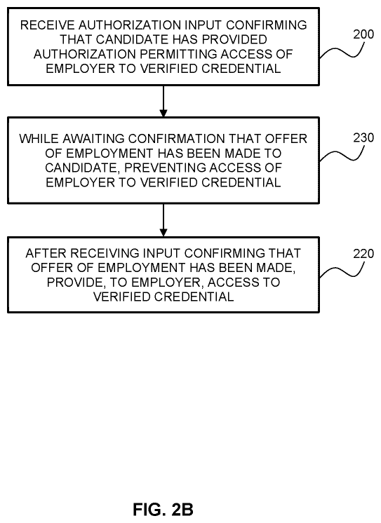

Referring now to FIG. 2A, an example automated method is provided for controlling access of an employer to a verified credential associated with a candidate during a hiring process, using a computing subsystem such as the central computing subsystem 100 shown in FIG. 1. The method illustrates operations that are implemented by one or more processors of the central computing subsystem based on the execution of instructions stored in memory.

In step 200, input is received by the central computing subsystem that authorizes, by the candidate, access of the employer to the verified credential. This input may further stipulate that the access of the employer to the verified credential is only authorized in the event that an offer of employment is made to the candidate by the employer. It will be understood, however, that despite having received the authorizing input, access of the employer to the verified credential is withheld by the central computing subsystem until further steps are performed that confirm that an offer of employment has been communicated to the candidate, as described further below with reference to steps 205-220 of FIG. 2A.

In some example embodiments, the verified credential may be obtained by the central computing subsystem in advance of the employer having determined to extend an offer of employment to the candidate, thereby effectively queuing the verified credential for subsequent viewing by the employer, conditional on the delivery of an offer of employment to the candidate. For example, the availability of the verified credential, and/or the authorization of the verified credential, may be communicated to the employer (e.g. via UI/API 145) prior to the communicating the offer of employment to the candidate. The verified credential may be stored in an encrypted state by the central computing subsystem.

The verified credential may be obtained, for example, by communicating with the trusted source of verified credentials 150, optionally through an API 155, as illustrated in FIG. 1. Such an example method of obtaining the verified credential may be initiated by the employer or by a recruiter associated with the employer, for example, after having obtained consent from the candidate. Accordingly, the employer or recruiter may communicate with the central computing subsystem 100, for example, via respective computing devices and UI/APIs 130,135 or 140, 145, with a requisition to obtain the verified credential associated with the candidate from the trusted source of verified credentials 150. After having obtained the verified credential, the verified credential may be stored, for example, locally, or via a remote database (e.g. in a distributed leger, as described further below).

In another example implementation, the verified credential may be obtained by the candidate, for example, prior to the recruitment process. For example, the candidate may communicate with the central computing subsystem 100, for example, via the candidate computing device 120 and associated UI/API 125, with a requisition to obtain the verified credential associated with the candidate from the trusted source of verified credentials 150. After having obtained the verified credential, the verified credential may be stored, for example, locally, or via a remote database, in association with candidate, or delivered to the candidate. Such an example implementation permits the candidate to market himself or herself as having been “prequalified”, for example, by displaying an indicator on a website (e.g. LinkedIn) or a digital resume indicating the availability of the verified credential, without providing direct access to the verified credential.

In other example implementations, the verified credential need not be obtained and stored by either the central computing subsystem or by the candidate. Instead, the central computing subsystem may communicate with the trusted source of verified credentials 150 to confirm the availability of the verified credential from the trusted source of verified credentials 150. The trusted source of verified credentials 150 may be subsequently instructed, by the central computing subsystem, after having confirmed that an offer of employment has been extended to the candidate, to permit access of the employer to the verified credential (for example, via API 155).

Referring back to step 200 of FIG. 2A, the input authorizing access of the employer to the verified credential may be received, for example, based as a transmission received by the central computing subsystem from the UI/API 125 operable on the candidate computing device 120 shown in FIG. 1. However, it will be understood that the authorizing input may be received according to a wide variety of implementations, including, for example, the transmission of a text message, an email message, and an HTTP request. In other example implementations, the authorization may be provided through an indirect modality in which the candidate posts, files, records, or otherwise provides the authorization to one or more data repositories that are accessible to the central computing subsystem, such as a database or a distributed ledger (the latter of which is described in more detail below).

The input may be provided according to many forms, and may optionally be encrypted (e.g. protected with a password or a decryption key accessible by the central computing subsystem). For example, the input may include an identifier associated with the employer, including, not limited to, the name of the employer, an encrypted identifier associated with the employer, such as a hash of an employer identifier (e.g. the employer name), and a key system.

The authorizing input may include one or more encryption measures that confirm the identity of the candidate, such as, for example, a signature generated with a private key associated with the candidate. The authorization may additionally or alternatively include one or more biometric measures, such as confirmation of the candidate identity via a facial scan (e.g. using a convolutional neural network to process the facial scan and confirm the identity of the candidate), or, for example, a fingerprint scan.

After having received the authorizing input from the candidate permitting the employer to access the verified credential, access of the employer to the verified credential is prevented until an offer of employment has been extended to the candidate, as described above. In the example implementation shown in FIG. 2A, steps 205-215 are performed to ensure that the offer of employment has been made before access to the verified credential is provided to the employer.

In step 205, a digital employment offer, purporting to include an offer of employment from the employer to the candidate, is received by the central computing subsystem. The digital offer of employment may take on many different forms, and is processed by the central computing subsystem to confirm the presence of the offer of employment, as per step 210 of FIG. 2A.

For example, the digital offer of employment may be an offer letter from the employer to the candidate. The offer letter may include, for example, a digital representation of text that can be searched for keywords indicative of an offer of employment. In some example implementations, the offer letter may be provided in the form of an optically scanned image of a printed or handwritten offer letter that may be processed according to a character recognition algorithm, such as optical character recognition algorithms known in the art, or, for example, using a deep learning based algorithm such as a convolutional neural network trained to recognize characters. In other example implementations, the digital employment offer may be text provided as input to one or more fields of a digital template (e.g. an offer letter template).

The text of the digital employment offer may be processed to determine the presence of an offer of employment according to many different example methods, such as, but not limited to, searching for specific words or phrases (e.g. “offer”, “compensation”, “salary”), and natural language processing machine learning algorithms. In some example implementations, as described further below, confirmation may be received from the candidate, after the candidate receives the offer of employment, confirming that an offer of employment has been received by the candidate, and/or confirmation may be received from the candidate confirming the outcome of the aforementioned automated determination of the presence of an offer of employment. Furthermore, a portal may be provided that facilitates the delivery of the offer of employment, by the employer, to the candidate, as a component of a smart contract (e.g. thereby facilitating an auditable offer of employment).

After having determined that the digital employment offer includes an offer of employment in step 210, the offer of employment is communicated to the candidate in step 215. This communication may be performed according to a wide variety of methods, including, but not limited to, the delivery of an email or text message delivery, an automated telephone message, or, for example, a notification generated by the UI/API 125. In example implementations in which the digital employment offer was provided as an offer letter addressed from the employer to the candidate, the offer letter may be directly communicated to the candidate.

After having both (i) determined that the digital offer employment offer included an offer of employment from the employer to the candidate and (ii) communicated the offer of employment to the candidate, the verified credentials may be beneficially provided to the employer as shown at step 220, thereby ensuring that the employer did not access the verified credentials prior to the offer of employment being provided to the candidate. In one example implementation, the verified credentials may be communicated (e.g. electronically delivered or transmitted) to the employer by the central computing subsystem, for example, via the UI/API 145 associated with the employer computing device 140, or via one or more additional or alternative delivery methods, including, but not limited to, email, text message, and display over a secure web page. The central computing subsystem may deliver the verified credential to the employer in an encrypted state. The encrypted state of the verified credential being generated according to a public key associated with the employer. Alternatively, access of the employer to the verified credential may be provided by communicating, with the central computing subsystem, to the employer, an encryption key suitable for decrypting an encrypted form of the verified credential.

In other example implementations, the central computing subsystem may communicate with the trusted source of verified credentials 150 to instruct the trusted source of verified credentials 150, to permit access of the employer to the verified credential (for example, via UI/API 155), thereby indirectly enabling the employer to access the verified credential.

In one example implementation, the central computing subsystem, after having delivered the offer of employment to the candidate, may continue to prevent access of the employer to the verified credential until further input is received from the candidate confirming receipt of the offer of employment.

In some example embodiments, after having provided the employer with access to the verified credential, the central computing subsystem may terminate access to the verified credential after a prescribed time duration.

The operations performed by the central computing system, as per FIGS. 1 and 2A, each provide a benefit to the employer who uses the system by virtue to ensure that access to the verified credential is only provided once an offer of employment has been made to the candidate. Step 200 is beneficial to the employer in view of the authorization of access that is provided by the candidate. Steps 205 and 210 are beneficial to the employer by ensuring that the digital employment offer is received and confirmed to include an offer of employment to the candidate, thereby assisting to ensure compliance with legislation requiring that access to the verified credential only being provided after communication of the offer of employment to the candidate. Likewise, step 215 automates the delivery of the offer of employment to the candidate, also ensuring compliance of the employer, by ensuring that the final step (step 220) is only performed after the delivery of the offer of employment to the candidate. Moreover, by automating each of steps 200-220, a clear and auditable digital record may be generated detailing the management and processing of the verified credential and the offer of employment, and thereby providing an unambiguous chain of custody associated with the verified credential that can be employed by the employer to demonstrate compliance with the governing legislation and/or regulations.

In other example implementations, it will be understood that some of the steps shown in FIG. 2A may be modified and/or omitted. For example, in some example implementation, the workflow of the central computing subsystem illustrated in FIG. 2A may be modified to omit step 210, with the assumption that the digital employment offer includes the offer of employment. While this workflow is not as robust as that of FIG. 2A, it may be deemed to be acceptable in some cases.

FIG. 2B illustrates an example embodiment where confirmation of the offer of employment is obtained indirectly, as opposed to the direct mechanism (the processing of the digital employment offer) shown in FIG. 2A. For example, in step 230, access of the employer to the verified credential is prevented while awaiting input confirming that an offer of employment has been made. The input confirming that the offer of employment has been made could be implemented, for example, by receiving, from the employer (e.g. as a message transmitted by the employer UI/API 145, or via another communication means as described above), a message or other form input. For example, the employer or recruiter may employ the UI 135/145 to indicate, via the selection of a graphical checkbox or toggle, that the offer of employment has been delivered. Additionally or alternatively, confirmation of receipt of the offer of employment could be communicated to the central computing subsystem by the candidate (e.g. as a message transmitted by the candidate UI/API 125, or via another communication means as described above). Additionally or alternatively, confirmation of delivery of the offer of employment could be communicated to the central computing subsystem by a third party having knowledge of the event, such as a recruiter (e.g. as a message transmitted by the recruiter UI/API 135, or via another communication means as described above).

Furthermore, in some example implementations, the authorization input received from the candidate may permit access of the employer to an additional credential that is not subject to the same legal restrictions as the first credential. In such a case, the second credential may be made available to the employer prior to the delivery of the offer of employment to the candidate.

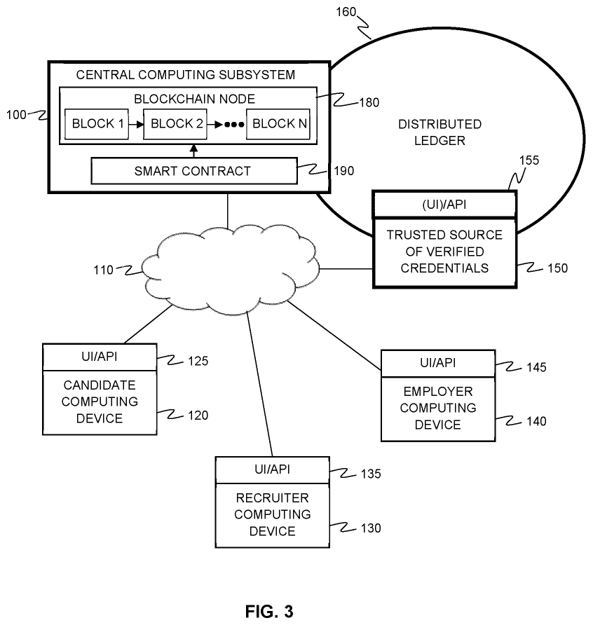

Referring now to FIG. 3, an alternative example system is shown in which authorization of the employer to access the verified credential is recorded on a distributed ledger 160. In the example embodiment shown in FIG. 3, the central computing subsystem 100 forms a node of the distributed ledger, with one or more additional computing devices forming one or more respective additional nodes of the distributed ledger. For example, in the example system shown in FIG. 3, the trusted source of verified credentials forms a node of the distributed ledger. The distributed ledger may be a blockchain, as shown, for example, in the schematic blockchain 180 shown residing within the central computing system 100.

In some example implementations, the central computing subsystem may store the verified credential, in an encrypted state, on the distributed ledger. For example, after communicating the offer of employment to the candidate, access of the employer to the verified credential may be provided by including, in the distributed ledger, an encrypted form of the verified credential, the encrypted form of the verified credential being generated according to a public key associated with the employer.

In some example embodiments, one or more properties associated with the permission status (permission granted or denied) of an employer to access a verified credential of a candidate may be stored as a state variable residing with the distributed ledger, as controlled by a smart contract, the smart contract facilitating the execution of transaction logic associated with the state variable of the distributed ledger. The smart contract may be stored within the blockchain, as in the Ethereum platform, or off-chain, as per a Hyperledger Fabric implementation of a distributed ledger. As shown in FIG. 3, the central computing subsystem 100 may create a smart contract 190 for execution in association with the distributed ledger. Alternatively, in implementations in which the candidate computing device forms a node of the distributed ledger, the candidate computing device may create a smart contract (e.g. via the UI/API 125).

In some example implementations, a smart contract may operate on a state variable defining the current authorization status of an employer to access a verified credential. For example, the central computing subsystem may obtain the current status (state) of the authorization input (e.g. as per step 200 of FIG. 2A) by executing function defined by a smart contract associated with the distributed ledger, the smart contract storing a state variable associated with a presence or absence of authorization of access of the employer to the verified credential. In some example implementations, the smart contract may be executed to modify the authorization status of an employer for accessing a verified credential. In some example implementations, the smart contract may be executed to remove/delete the ability of employer to access a verified credential after a prescribed time duration. In some example implementations, a smart contract may be executed to update a state variable associated with whether or not an offer of employment has been delivered from an employer to a candidate. In some example implementations, a smart contract may be executed to modify the encrypted form of a verified credential, such that the state variable is modified to be capable of being decrypted by an employer, when (i) an authorization status state variable has a value that permits the employer to access the verified credential, and (ii) an employment offer state variable has a value that indicates that an offer of employment has been delivered from the employer to the candidate.

In some example implementations, a smart contract may be employed to store information associated with the status of the following: the granting of permission of a candidate collect or otherwise obtain access to their background information, the granting of permission to document or list (for example, in a report), which elements of a background check have been verified, without providing results (details) associated with the background check; the offer of employment made by an employer to a candidate; and the granting of permission by the candidate, to view the results (details) of a background check. In some example implementations, the candidate may confirm, through a smart contract, that an offer of employment has been received. Such an example implementation may be beneficial in adding an additional confirmatory layer prior to providing access to the verified credentials.

In one example implementation, a process of controlling the authorization of an employed to verified credentials may be performed as follows:
1) The present example process begins with a candidate giving permission for the system to obtain and verify their credentials/background (e.g. including one or more of, but not limited to, education, job history, criminal background, social media check, motor vehicle record, credit history).
2) Once the credentials/background have been obtained/verified, the data details are encrypted and the candidate provides permission for the system to display a list of which elements (categories) of a background search have been completed (and results have been obtained). The candidate may share this information as part of their profile on an internet-based portal, such that an indication is provided that the results have been collected, without providing results and/or detailed information associated with the background check. For example, an indication may be provided an education credential has been verified, without providing details of the educational institution or the dates of attendance).
3) During the hiring process, an employer can review the list of which credentials were verified and if the potential employer elects to offer the candidate a job, the employer can request the details of the credentials/background along with indicating that a job has been offered.
4) When the candidate obtains the offer of employment, they can interact with the system to indicate that the offer has been received, and thereby provide permission to instantly decrypt and unlock the credentials/background, only for the employer that provided the employment offer.
5) Smart contacts may be employed in the granting of permissions and in polling/checking to determine whether or not (and/or when) an offer of employment has been made.
6) When a permission changes from no to yes, the state variable associated with that permission changes based on the logic of the smart contract. The block is then updated and all nodes on the block are synchronized to indicate this new state.
7) In some implementations, sharing of decrypted information can only occur if both the employer and the candidate indicate that a job has been offered and received, respectively.

While many of the present example embodiments have been explained in the context of an interaction between a candidate and an employer, it will be understood that the example systems and methods disclosed herein may be adapted to other applications that involve the need to verify credentials. For example, in some alternative example implementations, the present example methods can be adapted to facilitate the controlled authorization of access of verified credentials associated with a contract between a first entity and a second entity, during the establishment of a contractual relationship. Examples of such applications include, but are not limited to, interactions between an individual (or entity) and a second entity such as a landlord, mortgage broker, banker, leasing company or other financial entity. In some example implementations, the systems and methods may provide the capability to filter depending on the type of receiving entity (e.g. credit history vs. motor vehicle record (MVR); credit vs. criminal).

Referring now to FIG. 4, an example central computing subsystem 100 is shown including a processor 410, a memory 415, a system bus 405, a power source 425, a storage device 430, communications interface 435, a display 440, and one or more input/output devices 445.

The example methods described herein can be implemented, at least in part, via hardware logic in processor 410 and partially using the instructions stored in memory 415. Some example embodiments may be implemented using processor 410 without additional instructions stored in memory 415. Some embodiments may be implemented using the instructions stored in memory 415 for execution by one or more microprocessors.

For example, the example methods described herein for the management and authorization of access to a verified credential associated with a candidate, such as the example methods illustrated in FIGS. 2A and 2B, may be implemented via processor 410 and/or memory 415. The instructions for implementing such methods are represented in FIG. 4 as verified credential access management module 460.

It is to be understood that the example system shown in the figure is not intended to be limited to the components that may be employed in a given implementation. In one example implementation, a portion of the central computing subsystem 100 may be implemented, at least in part, on a remote computing system that connects to a local processing hardware via a remote network, such that some aspects of the processing are performed remotely (e.g. in the cloud), as noted above.

Although only one of each component is illustrated in FIG. 4, any number of each component can be included. For example, a computer typically contains a number of different data storage media. Furthermore, although the bus 410 is depicted as a single connection between all of the components, it will be appreciated that the bus 410 may represent one or more circuits, devices or communication channels which link two or more of the components. For example, in many computers, bus 410 often includes or is a motherboard.

Although some example embodiments of the present disclosure can be implemented in fully functioning computers and computer systems, various embodiments are capable of being distributed as a computing product in a variety of forms and are capable of being applied regardless of the particular type of machine or computer readable media used to actually effect the distribution.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices. As used herein, the phrases “computer readable material” and “computer readable storage medium” refers to all computer-readable media, except for a transitory propagating signal per se.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A system for controlling access to a verified credential associated with a candidate during recruitment, the system comprising:
a central computing subsystem comprising at least one processor and associated memory, the memory comprising instructions executable by said at least one processor to perform operations comprising:
receiving authorization input confirming that the candidate has provided authorization permitting access of an employer to the verified credential;
while preventing access of the employer to the verified credential:
receiving a digital employment offer purported to comprise of an offer of employment to the candidate from the employer;
processing the digital employment offer to confirm inclusion, in the digital employment offer, of the offer of employment to the candidate from the employer, thereby verifying the digital employment offer;
communicating the offer of employment to the candidate; and
after communicating the offer of employment to the candidate, providing access of the employer to the verified credential, thereby protecting the employer from accessing the verified credential prior to delivery of the offer of employment.

2. The system according to claim 1 wherein the digital employment offer comprises an offer letter, and wherein said central computing subsystem is configured to process the offer letter to identify, within the offer letter, the offer of employment to the candidate by the employer.

3. The system according to claim 2 wherein said central computing subsystem is configured to process the offer letter according to a natural language processing algorithm.

4. The system according to claim 2 wherein said central computing subsystem is configured to process the offer letter using a machine learning algorithm.

5. The system according to claim 1 wherein the digital employment offer is received, by said central computing subsystem, as a set of inputs associated with fields of an offer letter template, and wherein said central computing subsystem is configured to process at least one of the inputs to confirm a presence of the offer of employment.

6. The system according to claim 1 wherein said central computing subsystem is configured to receive, from the candidate, confirmation of receipt of the offer of employment prior to providing access of the employer to the verified credential.

7. The system according to claim 1 wherein said central computing subsystem is configured to communicate, to the employer, a presence of the verified credential, without providing access to the verified credential, prior to communicating the offer of employment to the candidate.

8. The system according to claim 1 wherein said central computing subsystem is configured such that access of the employer to the verified credential is terminated after a prescribed time duration.

9. The system according to claim 1 wherein the verified credential is a first verified credential, and wherein the authorization permits access of the employer to a second verified credential, and wherein said central computing subsystem is further configured to provide access of the employer to the second verified credential prior to communicating the offer of employment to the candidate.

10. The system according to claim 1 wherein said central computing subsystem is further configured to store the one or more of (i) the verified credential and (ii) permissions associated with the verified credential, in an encrypted state.

11. The system according to claim 1 wherein said central computing subsystem is connectable to a computing device associated with the candidate for receiving the authorization input.

12. The system according to claim 1 wherein said central computing subsystem forms a node of a distributed ledger, and wherein said central computing subsystem is configured to obtain the authorization input by executing a smart contract associated with the distributed ledger, the smart contract storing a state variable associated with a presence or absence of authorization of access of the employer to the verified credential.

13. The system according to claim 12 wherein said central computing subsystem is configured to store the verified credential, in an encrypted state, on the distributed ledger.

14. The system according to claim 1 wherein said central computing subsystem is configured such that, after communicating the offer of employment to the candidate, access of the employer to the verified credential is provided by including, in the distributed ledger, an encrypted form of the verified credential, the encrypted form of the verified credential being generated according to a public key associated with the employer.

15. The system according to claim 1 wherein said central computing subsystem is configured such that, after communicating the offer of employment to the candidate, access of the employer to the verified credential is provided by communicating an encrypted form of the verified credential to the employer, the encrypted form of the verified credential being generated according to a public key associated with the employer.

16. The system according to claim 1 wherein said central computing subsystem is configured such that, after communicating the offer of employment to the candidate, access of the employer to the verified credential is provided by communicating, to the employer, an encryption key suitable for decrypting an encrypted form of the verified credential.

17. A method of controlling access to a verified credential associated with a candidate during recruitment, the method comprising, employing a central computing subsystem to perform operations comprising:
receiving authorization input confirming that the candidate has provided authorization permitting access of an employer to the verified credential;
while preventing access of the employer to the verified credential:
receiving a digital employment offer purported to comprise of an offer of employment to the candidate from the employer;
processing the digital employment offer to confirm inclusion, in the digital employment offer, of the offer of employment to the candidate from the employer, thereby verifying the digital employment offer;
communicating the offer of employment to the candidate; and
after communicating the offer of employment to the candidate, providing access of the employer to the verified credential, thereby protecting the employer from accessing the verified credential prior to delivery of the offer of employment.

18. The method according to claim 17 wherein the digital employment offer comprises an offer letter, and wherein the offer letter is processed by the central computing subsystem to identify, within the offer letter, the offer of employment to the candidate by the employer.

19. The method according to claim 18 wherein the offer letter is processed by the central computing subsystem according to a natural language processing algorithm.

20. The method according to claim 18 wherein the offer letter is processed by the central computing subsystem using a machine learning algorithm.

21. The method according to claim 17 wherein the digital employment offer is received, by the central computing subsystem, as a set of inputs associated with fields of an offer letter template, and wherein at least one of the inputs are processed by the central computing subsystem to confirm a presence of the offer of employment.

22. The method according to claim 17 further comprising receiving, from the candidate, confirmation of receipt of the offer of employment prior to providing access of the employer to the verified credential.

23. The method according to claim 17 further comprising, prior to receiving a digital employment offer, employing the central computing subsystem to communicate, to the employer, a presence of the verified credential, without providing access to the verified credential.

24. The method according to claim 17 wherein the central computing subsystem is configured such that access of the employer to the verified credential is terminated after a prescribed time duration.

25. The method according to claim 17 wherein the authorization from the candidate permitting the employer to view the verified credential is conditional upon receipt of the offer of employment.

26. The method according to claim 1 wherein legislation within a jurisdiction in which one or both of the candidate and the employer reside prohibits disclosure of the verified credential prior to the provision of the offer of employment to the candidate, such that compliance of the employer with the legislation is automatically achieved by only permitting the employer to access the verified credential after the offer of employment is communicated to the candidate.

27. The method according to claim 17 wherein the verified credential is a first verified credential, and wherein the authorization permits access of the employer to a second verified credential, the method further comprising:
providing access of the employer to the second verified credential prior to communicating the offer of employment to the candidate.

28. The method according to claim 27 wherein the second verified credential is associated with an educational degree obtained by the candidate and the first verified credential is associated with a criminal background check performed on the candidate.

29. The method according to claim 17 wherein the verified credential is stored by the central computing subsystem in an encrypted state.

30. The method according to claim 17 wherein the authorization input is received from a computing device associated with the candidate.

31. The method according to claim 17 wherein the authorization input is obtained by executing, via the central computing subsystem, a smart contract associated with a distributed ledger, the smart contract storing a state variable associated with a presence or absence of authorization of access of the employer to the verified credential.

32. The method according to claim 31 wherein the verified credential is stored, in an encrypted state, on the distributed ledger.

33. The method according to claim 31 wherein the smart contract is executable by the candidate, through a user interface employing an application programming interface, to modify the state variable.

34. The method according to claim 31 wherein, after communicating the offer of employment to the candidate, access of the employer to the verified credential is provided by including, in the distributed ledger, an encrypted form of the verified credential, the encrypted form of the verified credential being generated according to a public key associated with the employer.

35. The method according to claim 17 wherein, after communicating the offer of employment to the candidate, access of the employer to the verified credential is provided by communicating an encrypted form of the verified credential to the employer, the encrypted form of the verified credential being generated according to a public key associated with the employer.

36. The method according to claim 17 wherein, after communicating the offer of employment to the candidate, access of the employer to the verified credential is provided by communicating, to the employer, an encryption key suitable for decrypting an encrypted form of the verified credential.

37. The method according to claim 17 wherein sourcing of the verified credential was initiated by the candidate.

38. The method according to claim 17 wherein sourcing of the verified credential was initiated by the employer.

39. A system for controlling access to a verified credential associated with a candidate during recruitment, the system comprising:
a central computing subsystem comprising at least one processor and associated memory, the memory comprising instructions executable by said at least one processor to perform operations comprising:
receiving first input confirming that the candidate has provided authorization permitting access of an employer to the verified credential;
while preventing access of the employer to the verified credential, awaiting second input confirming that an offer of employment has been made to the candidate by the employer; and
after receiving the second input confirming that an offer of employment has been made to the candidate by the employer, providing access of the employer to the verified credential, thereby protecting the employer from accessing the verified credential prior to delivery of the offer of employment.

40. A method of controlling access to a verified credential associated with a candidate during recruitment, the method comprising, employing a central computing subsystem to perform operations comprising:
receiving first input confirming that the candidate has provided authorization permitting access of an employer to the verified credential;
while preventing access of the employer to the verified credential, awaiting second input confirming that an offer of employment has been made to the candidate by the employer; and
after receiving the second input confirming that an offer of employment has been made to the candidate by the employer, providing access of the employer to the verified credential, thereby protecting the employer from accessing the verified credential prior to delivery of the offer of employment.

41. A system for controlling access to a verified credential associated with a first entity during a contract generation process, the system comprising:
a central computing subsystem comprising at least one processor and associated memory, the memory comprising instructions executable by said at least one processor to perform operations comprising:
receiving authorization input confirming that the first entity has provided authorization permitting access of a second entity to the verified credential;
while preventing access of the second entity to the verified credential:
receiving a digital document purported to comprise of a contract between the second entity and the first entity;
processing the digital document to confirm inclusion, in the digital document, of the contract between the second entity and the first entity, thereby verifying the digital document;
communicating the contract to the first entity; and
after communicating the contract to the first entity, providing access of the second entity to the verified credential, thereby protecting the second entity from accessing the verified credential prior to delivery of the contract.

42. A method of controlling access to a verified credential associated with a first entity during a contract generation process, the method comprising, employing a central computing subsystem to perform operations comprising:
receiving authorization input confirming that the first entity has provided authorization permitting access of a second entity to the verified credential;
while preventing access of the second entity to the verified credential:
receiving a digital document purported to comprise of a contract between the second entity and the first entity;
processing the digital document to confirm inclusion, in the digital document, of the contract between the second entity and the first entity, thereby verifying the digital document;
communicating the contract to the first entity; and
after communicating the contract to the first entity, providing access of the second entity to the verified credential, thereby protecting the second entity from accessing the verified credential prior to delivery of the contract.
